(19) United States
(12) Patent Application Publication
(10) Pub. No.: US 2010/0001919 A1
(43) Pub. Date: Jan. 7, 2010

(54) Antenna device having wave collector

(75) Inventor: Wei Long Hu, Tauyuan Hsien (TW)

Correspondence Address: CHARLES E. BAXLEY, ESQUIRE, 90 JOHN STREET, SUITE 309, NEW YORK, NY, 10038, US

(73) Assignee: Joymax Electronics Co., Ltd.

(21) Appl. No.: 12/217,080

(22) Filed: Jul. 1, 2008

(51) Int. Cl. H01Q 1/48; H01Q 9/04

(52) U.S. Cl. 343/848; 343/700 MS

(57) ABSTRACT

An antenna device includes a radiator disposed on an earth plate with one or more spacers, and a hood disposed on the earth plate with one or more pads which include a height greater than that of the spacers for allowing the hood to be supported at a distance greater than the radiator, and the radiator is disposed between the hood and the earth plate and spaced from the hood and the earth plate. The hood includes one or more boards each having a pattern for collecting waves or signals, and a spacing panel disposed between the boards. The patterns of the boards are preferably arranged in different direction for suitably collecting the waves or signals and for increasing the gain of the antenna device.

### BACKGROUND OF THE INVENTION

1. Field of the Invention

The present invention relates to an antenna device, and more particularly to an antenna device including a wave collector or wave collecting device for suitably collecting the waves or signals and for increasing the gain of the antenna device.

2. Description of the Prior Art

Typical antenna devices comprise one or more radiators disposed on an earth plate or a printed circuit board for transmitting or receiving waves or signals and for allowing the radiators to transmit or to receive waves or signals or different resonant frequencies.

For example, U.S. Patent Application Publication No. US 2001/0054979 A1 to Bahr et al., and U.S. Patent Application Publication No. US 2002/0104615 A1 to Lebaric et al. disclose two of the typical antenna devices each comprising a radiator disposed on an earth plate or a printed circuit board and disposed at a distance essentially parallel to the earth plate and conductively connected to the earth plate.

However, the typical antenna devices have no wave collector or wave collecting device to suitably collect the waves or signals such that the gain of the typical antenna devices may not be suitably increased.

U.S. Patent Application Publication No. US 2003/0117321 A1 to Furse et al. discloses another typical embedded antenna for measuring the electrical properties of materials and for determining the information regarding the materials being probed such as quality, composition, presence, and moisture content.

However, similarly the typical embedded antenna device also has no wave collector or wave collecting device to suitably collect the waves or signals such that the gain of the typical embedded antenna device may not be suitably increased.

The present invention has arisen to mitigate and/or obviate the afore-described disadvantages of the conventional antenna members or devices.

### SUMMARY OF THE INVENTION

The primary objective of the present invention is to provide an antenna device including a wave collector or wave collecting device for suitably collecting the waves or signals and for increasing the gain of the antenna device.

In accordance with one aspect of the invention, there is provided an antenna device comprising an earth plate, a radiator disposed on the earth plate with at least one spacer and disposed at a distance from the earth plate with the spacer, and a hood disposed on the earth plate with at least one pad and disposed at a distance from the earth plate with the pad, and the pad including a height greater than that of the spacer for allowing the hood to be supported at a distance greater than the radiator, and the radiator being disposed between the hood and the earth plate and spaced from the hood and the earth plate for decreasing the volume of the antenna device and for increasing the gain of the antenna device.

The earth plate includes a grounded upper surface, and the earth plate includes a feed attached to a bottom portion of the earth plate.

The hood includes an area greater than that of the radiator for allowing the radiator to be covered or shielded or protected below the hood.

The hood includes a first board having a pattern for collecting waves or signals.

The hood may further include at least one second board superposed with the first board, and a spacing panel disposed between the first board and the second board for suitably spacing the boards from each other.

The second board includes a pattern for collecting waves or signals. The pattern of the second board and the pattern of the first board are preferably arranged in different direction for suitably collecting the waves or signals.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of an antenna assembly in accordance with the present invention;

FIG. 2 is a perspective view illustrating one of the antenna devices of the antenna assembly in accordance with the present invention;

FIG. 3 is a side plan schematic view of the antenna device;

FIG. 4 is a partial exploded view of the antenna device;

FIG. 5 is a bottom plan schematic view of the antenna device;

FIG. 6 is another partial exploded view of the antenna device;

FIG. 7 is a plan schematic view illustrating the erected or vertical plane (E-Plane) of the radiation of the antenna device when conducted with a frequency of 3500 MHz; and

FIG. 8 is another plan schematic view illustrating the horizontal plane (H-Plane) of the radiation of the antenna device when conducted with the frequency of 3500 MHz.

### DETAILED DESCRIPTION OF THE PREFERRED EMBODIMENT

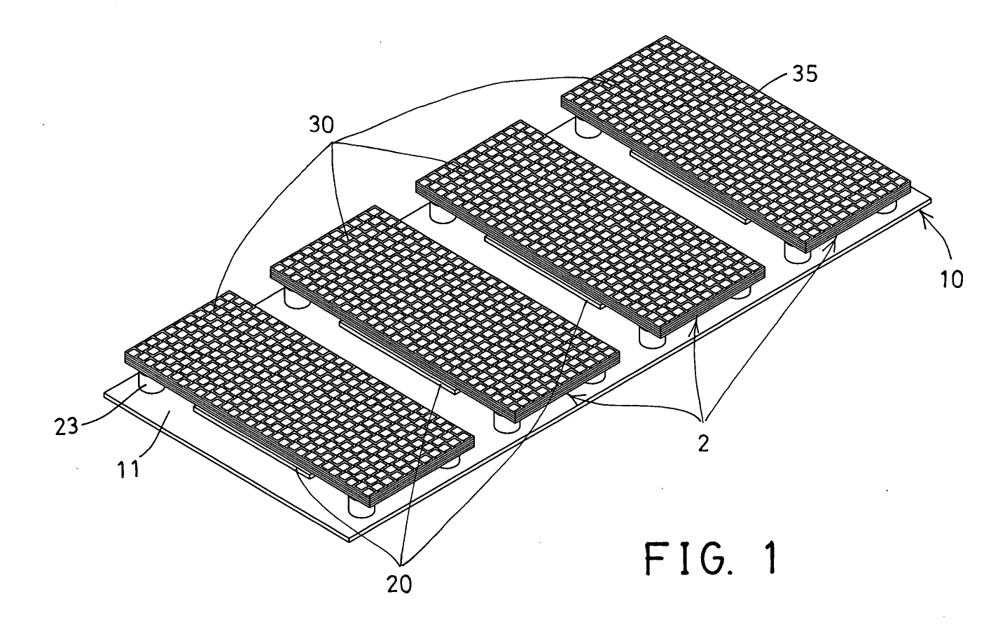

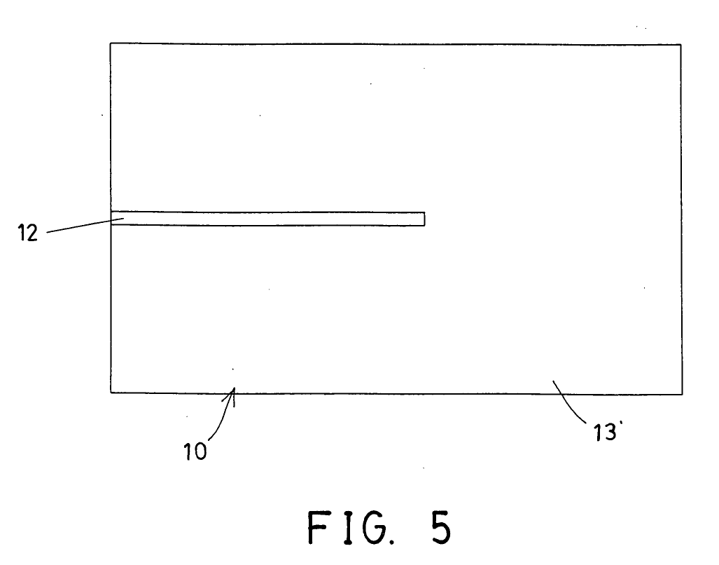

Referring to the drawings, and initially to FIG. 1, an antenna assembly in accordance with the present invention comprises a printed circuit board or an earth plate 10 including a grounded upper surface 11, and including a feed 12 (FIG. 5) provided or attached to the lower or bottom portion 13 of the earth plate 10 for transmitting or receiving waves or signals. One or more (such as four) antenna devices 2 are attached to or disposed on the earth plate 10.

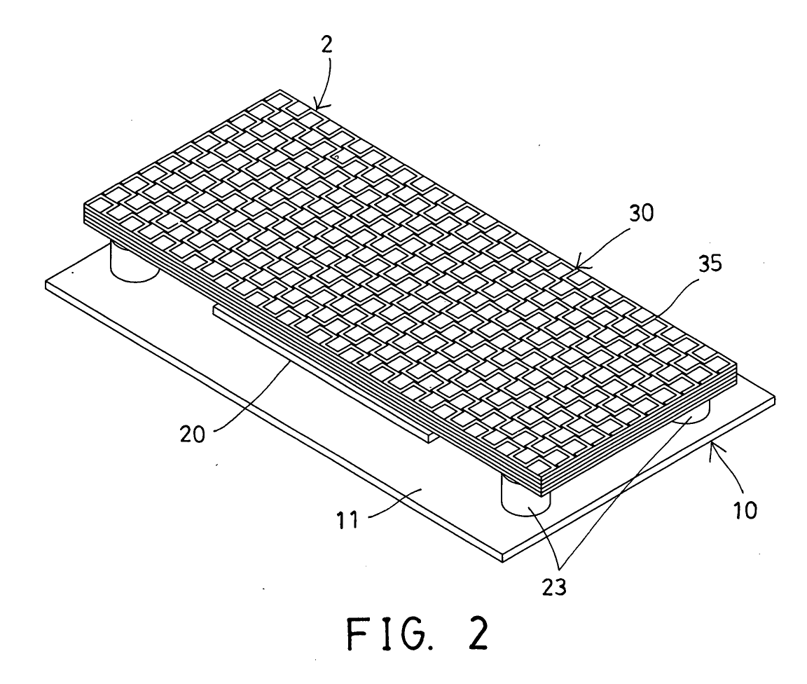

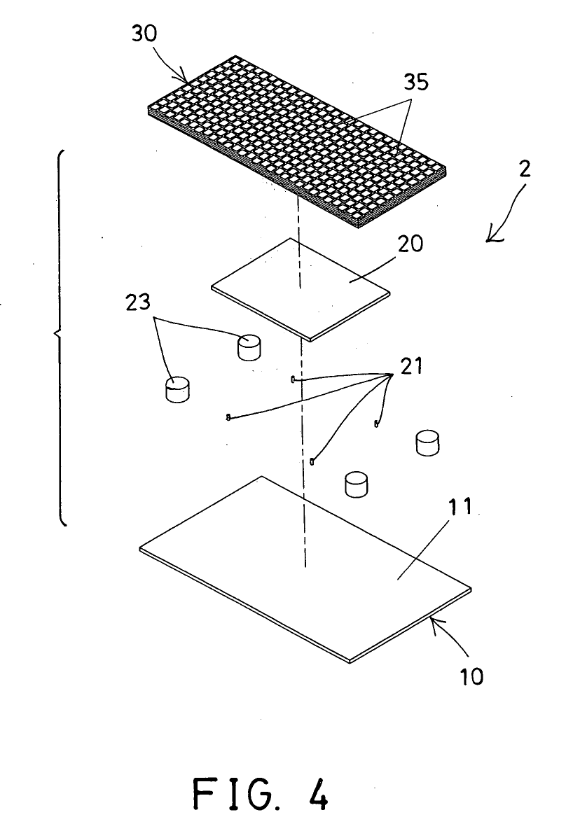

As shown in FIGS. 2-4, illustrated is one of the antenna devices 2 which includes an antenna member or radiator 20 attached to or disposed on the earth plate 10 with one or more insulators or spacers 21 and disposed at a distance essentially parallel to the earth plate 10 with the spacers 21, and includes a wave collector or wave collecting device or hood 30 attached to or disposed on the earth plate 10 with one or more insulators or spacers or pads 23 and disposed at a distance essentially parallel to the earth plate 10 with the pads 23.

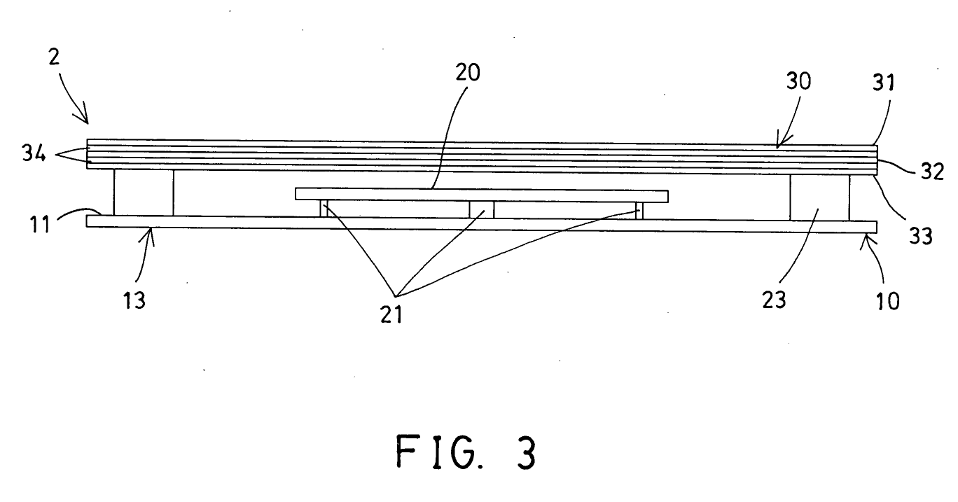

As best shown in FIG. 3, the pads 23 include a thickness or height greater than that of the spacers 21 for allowing the hood 30 to be supported at a distance greater than the radiator 20, and for allowing the radiator 20 to be supported or disposed below the hood 30 and to be supported or disposed between the hood 30 and the earth plate 10 and spaced from the hood 30 and the earth plate 10 for transmitting or receiving the waves or signals. It is preferable that the hood 30 includes a plane or area greater than that of the radiator 20 for allowing the radiator 20 to be suitably covered below the hood 30.

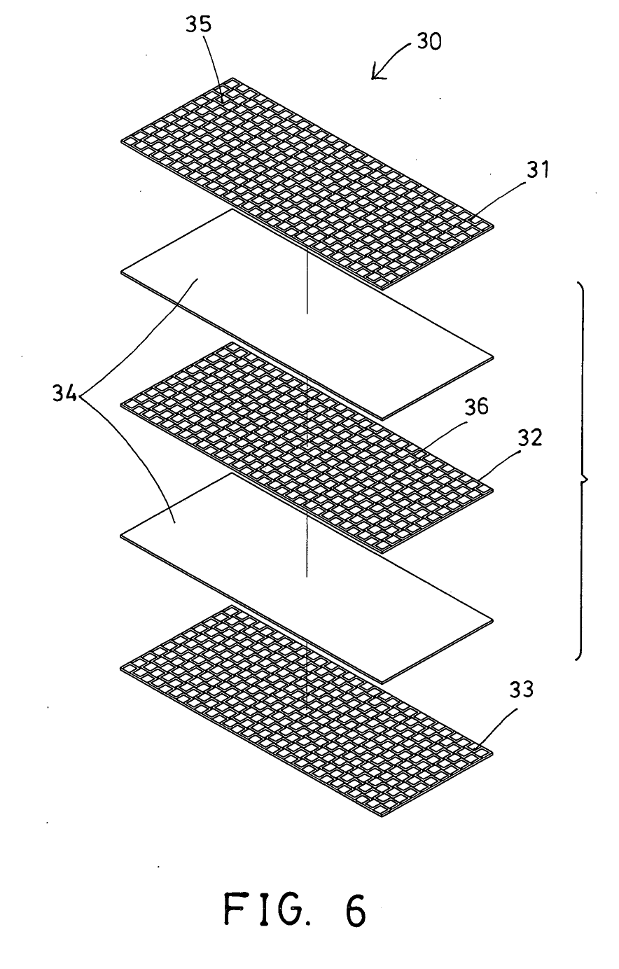

As shown in FIG. 6, the hood 30 includes two or more boards 31, 32, 33 superposed with each other, and one or more insulators or spacing panels 34 disposed between the boards 31-33 and made of insulating materials, such as glass fibers, carbon fibers, or other composite materials for separating the boards 31-33 from each other. The boards 31, 33 each include a pattern 35, such as a square-shaped wave pattern 35 provided or attached or typed or printed thereon, and the other board 32 which is disposed between the boards 31, 33 also include a pattern 36, such as a square-shaped wave pattern 36 provided or attached or typed or printed thereon. It is preferable that the pattern 36 of the board 32 and the patterns 35 of the boards 31, 33 are arranged in different direction or arranged opposite to each other for suitably collecting the waves or signals and for increasing the gain of the antenna device 2.

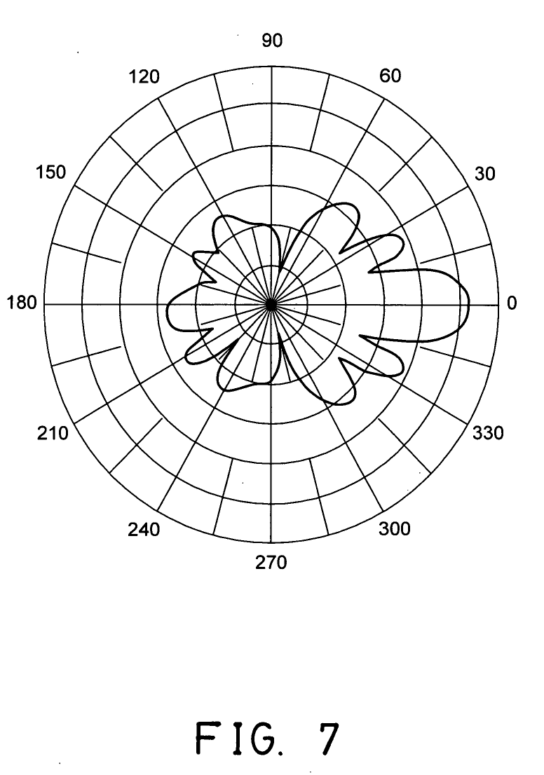

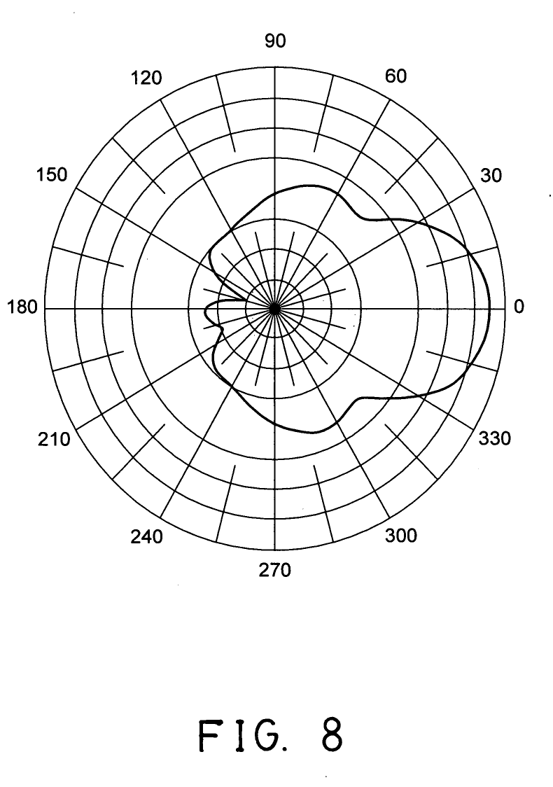

It is to be noted that the radiator 20 is supported or disposed below the hood 30 and supported or disposed between the hood 30 and the earth plate 10 for allowing the volume of the antenna device 2 to be suitably decreased, and the patterns 35, 36 of the boards 31-33 may be used to suitably collect the waves or signals and to increase the gain of the antenna device 2. For example, as shown in FIGS. 7 and 8, illustrated are the erected or vertical plane (E-Plane) and the horizontal plane (H-Plane) of the radiation of the antenna device 2 respectively when conducted with a frequency of 3500 MHz.

Accordingly, the antenna device in accordance with the present invention includes a wave collector or wave collecting device for suitably collecting the waves or signals and for increasing the gain of the antenna device.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An antenna device comprising:
an earth plate,
a radiator disposed on said earth plate with at least one spacer and disposed at a distance from said earth plate with said at least one spacer, and
a hood disposed on said earth plate with at least one pad and disposed at a distance from said earth plate with said at least one pad, and said at least one pad including a height greater than that of said at least one spacer for allowing said hood to be supported at a distance greater than said radiator, and said radiator being disposed between said hood and said earth plate and spaced from said hood and said earth plate.

2. The antenna device as claimed in claim 1, wherein said earth plate includes a grounded upper surface.

3. The antenna device as claimed in claim 1, wherein said earth plate includes a feed attached to a bottom portion of said earth plate.

4. The antenna device as claimed in claim 1, wherein said hood includes an area greater than that of said radiator for allowing said radiator to be covered below said hood.

5. The antenna device as claimed in claim 1, wherein said hood includes a first board having a pattern for collecting waves or signals.

6. The antenna device as claimed in claim 5, wherein said hood includes at least one second board superposed with said first board, and a spacing panel disposed between said first board and said at least one second board.

7. The antenna device as claimed in claim 6, wherein said at least one second board includes a pattern for collecting waves or signals.

8. The antenna device as claimed in claim 7, wherein said pattern of said at least one second board and said pattern of said first board are arranged in different direction.
